(19) United States
(12) Patent Application Publication
(10) Pub. No.: US 2016/0330673 A1
(43) Pub. Date: Nov. 10, 2016

(54) ADVERTISING STORAGE CAPABILITIES ACCESSIBLE VIA A WIRELESS LOCAL AREA NETWORK

(71) Applicant: ALCATEL LUCENT, Boulogne-Billancourt (FR)

(72) Inventors: Martin VIGOUREUX, Nozay (FR); Michel LE PALLEC, Nozay (FR)

(73) Assignee: ALCATEL LUCENT, Boulogne-Billancourt (FR)

(21) Appl. No.: 15/107,990

(22) PCT Filed: Jan. 16, 2015
(86) PCT No.: PCT/EP2015/050748

§ 371 Date: Jun. 24, 2016

(30) Foreign Application Priority Data
Jan. 20, 2014 (EP) 14305073.0

(51) Int. Cl. H04W 48/10; H04W 48/16; H04W 8/22

(52) U.S. Cl. CPC H04W 48/10; H04W 8/22; H04W 48/16; H04W 84/12

(57) ABSTRACT

A method for advertising capabilities of at least one storage accessible via a wireless local area network that includes at least one wireless access point, which periodically transmits beacon frames containing a wireless local area network identifier designating this network, includes inserting, in each beacon frame transmitted by a wireless access point, data describing the capabilities of at least one storage accessible via the wireless local area network designated by this wireless local area network identifier.

### BACKGROUND OF THE INVENTION

1. Field of the Invention

The present invention generally relates to the wireless local area networks, for instance those standardized in the standard family IEEE 8502.11x (x being ‘b’, ‘g’, ‘n’, ‘ac’, etc) and marketed under the name WiFi.

Network attached storages are today being more and more deployed in WiFi wireless local area networks, these networks offering open access (e.g. hotspots in public places) or offering community-restricted access (e.g. access restricted to subscribers of a given Internet Service Provider). Also, more and more, residential home and small-office/home-office gateways are providing both WiFi access and storages.

However the capabilities (presence, availability, capacity, etc) of storage resources/devices, accessible through a given WiFi access point, are not known a priori by the users that would be allowed to connect to this WiFi access point. Only the owner and/or administrator of this WiFi access point, or the owner and/or administrator of the local area network behind it, has this knowledge.

2. Description of the Prior Art

A possible solution could be to advertise, by means of an independent medium, the existence and capabilities of storage resources/devices accessible through a given WiFi access point. As an illustrative example, once connected to a WiFi access point, a user, opening his/her browser, could be prompted by a page describing the capabilities of storage resources/devices accessible via this access point. However, this solution has a drawback: It is not possible to know the storage capabilities without being already connected to the related WiFi access point. This is particularly cumbersome in the now quite common situation where multiple WiFi networks are available at a given place. In such a situation, a user would have to connect to (and disconnect from) the various WiFi networks to discover their respective storage capabilities.

Thus, there is a need to provide a better technical solution for advertising the capabilities of storage resources/devices that are accessible via a wireless local area network.

This can be solved by applying, the method according to the invention.

### SUMMARY OF THE INVENTION

A first object of the invention is a method for advertising capabilities of at least one storage resource accessible via a wireless local area network comprising at least one wireless access point this wireless access point periodically transmitting a beacon frame containing a wireless local area network identifier designating this network;

characterized in that it comprises the step of inserting, in beacon frames transmitted by a wireless access point, data describing the capabilities of at least one storage accessible via the wireless local area network designated by this wireless local area network identifier.

Thanks to the combination, within a beacon frame, of the wireless local area network identifier designating a network and of the data describing the storage capabilities attached to this network, a terminal is able to identify storage capabilities attached to the neighboring wireless network without the need to establish any prior connection to these wireless networks. When several wireless local area networks are available, with respective attached storage resources, a terminal can advantageously select the wireless network presenting the best matching between network resources, including storage resources, and client objectives in terms of remote storage service.

A second object of the invention is a wireless access point for implementing the method according to the invention.

A third object of the invention is a wireless terminal for implementing the method according to the invention.

Other features and advantages of the present invention will become more apparent from the following detailed description of embodiments of the present invention, when taken in conjunction with the accompanying drawings.

### BRIEF DESCRIPTION OF THE DRAWINGS

In order to illustrate in detail features and advantages of embodiments of the present invention, the following description will be with reference to the accompanying drawings. If possible, like or similar reference numerals designate the same or similar components throughout the figures thereof and description, in which:

FIG. 1 represents exemplary wireless local area networks where the method according to the invention is applied.

FIG. 2 represents the generic format of an information element according to the standard family IEEE802.11x.

FIG. 3 represents the generic format of a peculiar information element that is specific to a vendor, according to the standard family IEEE802.11x.

FIG. 4 represents the generic format of a sub-element, according to the standard family IEEE802.11x.

FIG. 5 represents the format of a newly defined storage capability advertising information element, according to a first embodiment of the method according to the invention.

FIG. 6 represents the format of a newly defined storage capability advertising information element, according to a second embodiment of the method according to the invention.

### DETAILED DESCRIPTION OF THE PREFERRED EMBODIMENTS

The following description of embodiments focuses on the WiFi technology, but the method according to the invention can also apply to other kinds of wireless networks especially wireless networks that are non-subscriber-based with a limited-coverage

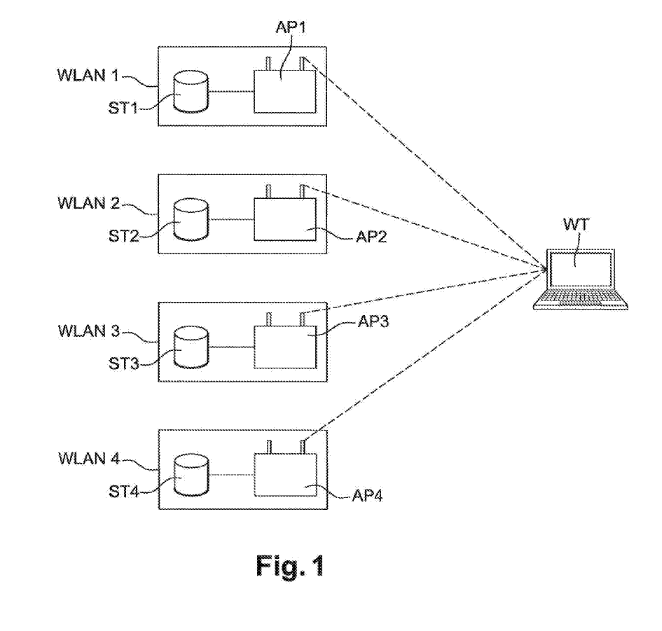

FIG. 1 represents four exemplary wireless local area networks WLAN1, WLAN2, WLAN3, WLAN4, where the method according to the invention is applied. The wireless local area network WLAN1 comprises an access point AP1 and a storage ST1. The wireless local area network WLAN2 comprises an access point AP2 and a storage ST2. The wireless local area network WLAN3 comprises an access point AP3 and a storage ST3. The wireless local area network WLAN4 comprises an access point AP4 and a storage ST4. These local area networks comprise other network elements that are classical and not represented on this figure.

An exemplary wireless terminal WT, according to the invention, is within the connectivity area of the four access points AP1, . . . , AP4 in this example. The wireless terminal WT may be a personal computer, a smartphone, etc, comprising a WiFi adapter/receiver.

WiFi technologies are defined and specified by the standard family IEEE802.11x. This IEEE standard family defines a “beacon frame” which is periodically sent by each of the WiFi access points of a wireless network. This beacon frame advertises information related to the wireless network WLAN. In particular, it classically contains a wireless local area network identifier designating this wireless network WLAN. According to the standard family IEEE 802.11x, the beacon frame may also contain several “information elements”, of various respective lengths.

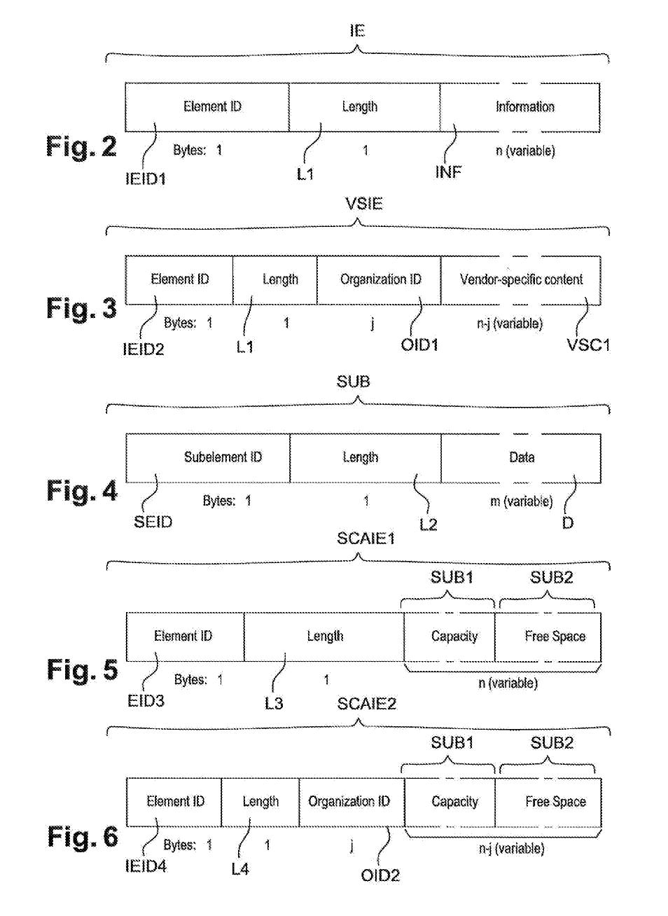

FIG. 2 represents the generic format of an information element according to the standard family IEEE802.11x:
A header of one byte (Eight bits) represents the identity IEID1 of the information element. It has a value chosen from 0 to 255.
One byte represents the length L1 of the information element.
A variable number n of bytes carrying data that may represent any kind of information INF.

FIG. 3 represents the generic format of a peculiar type of information element, an information element that is specific to a vendor, according to the standard family IEEE802.11x:
A peculiar header of one byte represents the identity IEID2 of this kind of information element: the standard sets its value at 221 for any vendor.
One byte represents the length L2 of this information element.
The n bytes carrying data comprise:
   j bytes representing an organisation identifier OID1, this organization identifier generally designating a vendor.
   and n-j bytes of data representing some vendor specific content VSC.

According to the standard family IEEE802.11x, any information element may contain one or several “information sub-elements” among the bytes carrying information, INF or VSC.

FIG. 4 represents the generic format of a sub-element, SUB, according to the standard family IEEE802.11x. It comprises:
A header of one byte that is the identifier SEID of the sub-element. This sub-element identifier SEID is relevant only in the context of a given information element.
One byte represents the length L2 of the sub-element.
A variable number m of bytes carrying data D.

In this example, the method according to the invention comprises the step of inserting, in each beacon frame transmitted by the wireless access point AP1, data describing the capabilities of at least one storage, such as the storage ST1, accessible via the wireless local area network WLAN1 designated by the wireless local area network identifier classically carried by this beacon frame.

Similarly data describing the capabilities of the storage ST2, ST3, ST4 are inserted in each beacon frame transmitted by the wireless access point AP2, AP3, and AP4 respectively.

In other examples, data describing the capabilities of at least one storage is inserted in each beacon frame out of k beacon frames, k being equal to 2, or 3, etc.

When the method according to the invention is applied to WiFi wireless networks, the data describing the capabilities of at least one storage are inserted in a newly defined information element, within a WiFi beacon frame. More precisely, the capabilities are represented by data carried inside at least one sub-element embedded in this newly defined information element.

Two embodiments of this newly defined information element, within a WiFi beacon frame, can be considered:

1) The first one should be used if the format of this newly defined information element is standardized in the future.
2) The second embodiment should be used if the format of this newly defined information element is not standardized in the future.

FIG. 5 represents the format the first embodiment SCAIE of the newly defined information element. It is similar to the generic information element IE represented on FIG. 2. It comprises:
A header, of one byte, that is the same for all the information elements carrying information about storage capabilities. This header has a specific value EID3 that will be chosen between 0 and 255, and that is supposed to be standardized in the future. This standardized specific value will enable recognizing any information element that advertises storage capabilities.

So any terminal compliant with the future standard will be able to recognize an information element advertising storage capabilities, by detecting this header.
One byte that represents the length L3 of this information element.
A sub-element SUB1 that contains the value of the total storage space of the wireless network, i. e. the capacity of the storage ST in the example of FIG. 1. This sub-element is similar to the sub-element represented on FIG. 4. It comprises a specific header (not represented) indicating that it carries the value of the total storage space.
A sub-element SUB2 contains the value of the free storage space of the wireless network, i. e. the free space of the storage ST in the example of FIG. 1. It is similar to the sub-element represented on FIG. 4. It comprises another specific header (not represented) indicating that it carries the value of the free storage space.

FIG. 6 represents the format the second embodiment SCAIE2 of the newly defined information element. It should be used if no specific header is standardised for all the information elements carrying information about storage capabilities, in the future. It is similar to the generic vendor specific information element VSIE represented on FIG. 2, except that the vendor specific content is specific. It comprises:
A header EID2 having the value 221 already standardised for the vendor specific information elements;
One byte represents the length L4 of this information element.
The n bytes carrying data comprise:
   j bytes representing an organisation identifier OID2, this organization identifier generally designating a vendor. Only the wireless terminals that will be configured for recognizing the specific organization identifier OID2 will be able to exploit this information element SCAIE2.
   and n-j bytes comprising a sub-element SUB1 advertising the capacity of the storage ST, and a sub-element SUB2 advertising the free space of the storage ST.

According to the invention, the data carried by a sub-element represent at least one of one of the capabilities of the storage or storages accessible via the access point that transmits the information element that comprises this sub-element. These capabilities may be:
The total storage space of the storage ST (expressed in bytes).
The free storage space of the storage ST (expressed in bytes).
The file system of the storage ST (e.g. FAT, FAT32, extFAT, NTFS, ext2, ext3, . . . )
The type of the storage space ST (public/shared or private).
The duration a file can be hosted in the storage ST before being automatically removed.
The access time (expressed in seconds).
The input/output throughput (reading/writing speed in bytes/second)
etc.

In this embodiment, the transmitted capabilities are limited to the total storage space and the free storage space of the storage ST. Of course, in other embodiments, a storage capability advertising information element may contain more or less capabilities. Preferably, a storage capability advertising information element comprises one distinct sub-element for each storage capability.

The choice of the capabilities that are advertised in the beacon frame is a trade off: On the one hand, the beacon frames must not be overloaded by the data representing these storage capabilities. On the other hand, the advertised capabilities must be sufficient for enabling a relevant choice of a wireless network. The advertised capabilities are chosen so that they enable a user or a software module, to efficiently select the best wireless network among several available wireless networks, and then connect to it. Additionally to wireless transmission capabilities, the storage capabilities are taken into account for selecting the wireless network meeting user/client, expectations in terms of (storage) service.

If a wireless network comprises several distinct storages, a sub-element preferably carries the total —preferably free—storage space that is accessible via the wireless network.

The owner(s) or administrator(s) of the different WiFi access points AP1, . . . , AP4 configures all these access points AP1, . . . , AP4 for periodically transmitting a beacon frame comprising the information element SCAIE1 or SCAIE2, in the same way as he/she classically configures the access points for transmitting a beacon frame comprising classical WiFi parameters such as the identifier of the wireless network.

For taking into account load balancing strategies between storage resources or for imposing some priority attributes, the owner(s) or administrator(s) of the WiFi access points AP1, . . . , AP4 may limit the value representing the (free) storage capacity, in order to advertise only a part of the storage resources to WiFi clients.

The embodiment WT of the wireless terminal according to the invention comprises a processor that runs client software configured for implementing the method according to the invention, i.e. doing the following steps:
Receiving a beacon frame in the wireless terminal WT;
Extracting a wireless local network identifier, from the received beacon frame. It designates one of the networks WLAN1, WLAN2, WLAN3, and WLAN4 in the example of FIG. 1.
Recognizing, in each beacon frame, one or several information element carrying information about storage capabilities. It may be either one of the two information elements SCAIE1, SCAIE2 described with reference to the FIGS. 5 and 6.
Extracting, from the information element(s) carrying information about storage capabilities, the sub-elements describing storage capabilities.

In the example of FIG. 1, the sub-elements extracted from the beacon frame transmitted by the access point AP1 describe the capabilities of storage ST1 attached to the wireless network WLAN1. The sub-elements extracted from the beacon frame transmitted by the access point AP2 are describing the capabilities of storage ST2 attached to the wireless network WLAN2. The sub-elements extracted from the beacon frame transmitted by the access point AP3 are describing the capabilities of storage ST3 attached to the wireless network WLAN3. The sub-elements extracted from the beacon frame transmitted by the access point AP4 are describing the capabilities of storage ST4 attached to the wireless network WLAN4.

For the step of recognizing, in the beacon frame, an information element carrying information about storage capabilities, two cases must be distinguished:
1) If a specific header is standardised, in the future, for all the information elements carrying information about storage capabilities, it consists in recognizing this specific header IEID 3.
2) If no specific header is standardised, in the future, for all the information elements carrying information about storage capabilities, it consists in:
   Recognizing the specific header IEID4 (value 221) already standardized for all the vendor specific information elements.
   Then, if it has been recognized as a vendor specific information element, then recognizing a given organization identifier OID2 in this information element.

In both cases information sub elements are used for depicting storage capabilities.

In a first embodiment of the terminal, the client software displays the storage capabilities for each accessible wireless local area network WLAN1, WLAN2, WLAN3, WLAN4, and prompts the user to choose one of them. The user manually selects one wireless local area network.

In a second embodiment of the terminal, the client is configured for automatically selecting one wireless local area network as a function of both advertised wireless transmission capabilities and advertised information about the respective storage capabilities of these wireless local area networks.

After the selection of a wireless local area network, client software connects the terminal WT to the selected wireless local area network. The connection is set up via one of the access points corresponding to the selected wireless local area network. Client software may request additional information about the storage capabilities, in a classical way, i. e. after connecting to the selected wireless local area network. For instance, if the local area WLAN4 has been selected, and if the beacon frames transmitted by the access point AP4 advertise only the value of the total storage space of the wireless local area network WLAN4, then the client may send a request, in order to request the value of the free storage space in the wireless local area network WLAN4, after connecting the terminal WT to the access point AP4.

The invention enables advertising storage capabilities before any connection. Nevertheless, after connecting the terminal to the selected network, an authorization step may still be applied for accessing to the storage resources of the selected network.

1) A method for advertising capabilities of at least one storage accessible via a wireless local area network comprising at least one wireless access point, this wireless access point periodically transmitting a beacon frame containing a wireless local area network identifier designating this network;
wherein it comprises the step of inserting, in beacon frames transmitted by a wireless access point, data describing the capabilities of at least one storage accessible via the wireless local area network designated by this wireless local area network identifier.

2) Method according to claim 1, further comprising the steps of:
receiving a beacon frame in a wireless terminal;
extracting the wireless local area network identifier designating this network;
and extracting, from the received beacon frame, data describing the capabilities of a storage accessible via the wireless local area network.

3) Method according to claim 1, wherein the wireless local area network complies with the standard family IEEE802.11; and this method comprising the step of carrying data, describing the capabilities of at least one storage, in at least one sub-element of an information element as specified by the standard family IEEE802.11x.

4) Method according to claim 1, wherein the data carried by a sub-element represent at least one of the following capabilities of at least one storage accessible via the access point:
the total storage space of this storage,
the free storage space,
the file system of this storage,
the type of this storage,
the duration a file can be hosted before being automatically removed from this storage,
the access time,
the input/output throughput.

5) An access point, for a wireless local area network, comprising a processor configured for:
storing a wireless local area network identifier;
and for inserting this stored wireless local area network identifier in each beacon frame transmitted by this wireless access point;
wherein this processor is also configured for:
storing data describing the capabilities of at least one storage accessible via the wireless local area network designated by this wireless local area network identifier,
and for inserting, in beacon frames transmitted by this wireless access point, the stored data describing the capabilities of at least one storage accessible via the wireless local area network designated by this wireless local area network identifier.

6) An access point according to claim 5, for a wireless local area network complying, with the standard family IEEE802.11x, comprising a processor configured for inserting data, describing the capabilities of at least one storage, in at least one sub-element of an information element according to the standard family IEEE802.11x.

7) A wireless terminal, wherein it comprises a processor configured for:
receiving a beacon frame transmitted by a wireless access point of a wireless local area network;
and extracting a wireless local area network identifier, from the received beacon frame,
wherein the processor is also configured for:
recognizing, in the beacon frame, data carrying information about storage capabilities,
and extracting, from the recognized data, the information about storage capabilities.

8) A wireless terminal according to the claim 7, compliant with the standard family IEEE802.11x, wherein,
for recognizing data carrying information about storage capabilities, the processor is configured for detecting, in the beacon frame, an information element having a header the value of which is specific for all the information elements advertising storage capabilities;
and wherein, for extracting, from the recognized data, the information about storage capabilities, the processor is configured for extracting this information from sub-elements carried by the detected information element.

9) A wireless terminal according to the claim 7, compliant with the standard family IEEE802.11x, wherein,
for recognizing data carrying information about storage capabilities, the processor is configured for:
detecting, in the beacon frame, an information element having a header the value of which is specific for all the information elements carrying vendor specific content,
and detecting in the detected information element, a predetermined organization identifier;
and wherein, for extracting, from the recognized data, the information about storage capabilities, the processor is configured for extracting this information from sub-elements carried by the detected information element.

10) A wireless terminal according to claim 7, wherein the processor is further configured for automatically selecting a wireless local area network among several wireless local area networks, as a function of advertised information about the respective storage capabilities of these wireless local area networks.

11) A computer program product for an access point, for a wireless local area network, comprising computer-executable instructions for performing the steps of:
storing a wireless local area network identifier designating this wireless local area network,
and for inserting, in each beacon frame transmitted by this wireless access point, the stored wireless local area network identifier;
wherein it further comprises computer-executable instructions for performing the steps of
storing data describing the capabilities of at least one storage accessible via the wireless local area network designated by this wireless local area network identifier,
and for inserting, in beacon frames transmitted by this wireless access point, stored data describing the capabilities of at least one storage accessible via a wireless local area network designated by this wireless local area network identifier.

12) A computer program product according to claim 11, for a wireless local area network complying with the standard family IEEE802.11x, comprising computer-executable instructions for performing, when the program is run on a computer, the step of inserting data, describing the capabilities of at least one storage, in at least one sub-element of an information element according to the standard family IEEE802.11x.

13) A computer program product for a wireless terminal, comprising computer-executable instructions for performing, when the program is run on a computer, the steps of:
receiving a beacon frame in the wireless terminal;
extracting, from the received beacon frame, a wireless local area network identifier designating the wireless local area network;
wherein it further comprises computer-executable instructions for performing the steps of extracting, from the received beacon frame, data describing the capabilities of a storage accessible via the wireless local area network designated by the extracted wireless local area network identifier.

14) A computer program product according to claim 13, for a wireless terminal compliant with the standard family IEEE802.11x, comprising computer-executable instructions for performing, when the program is run on a computer, the steps of:
recognizing data carrying information about storage capabilities, the processor is configured for detecting, in the beacon frame, an information element having a header the value of which is specific for all the information elements advertising storage capabilities;
and extracting, from the recognized data, the information about storage capabilities, the processor is configured for extracting this information from sub-elements carried by the detected information element.

15) A computer program product according to claim 13, for a wireless terminal compliant with the standard family IEEE802.11x, comprising computer-executable instructions for performing, when the program is run on a computer, the steps of:
recognizing data carrying information about storage capabilities, the processor is configured for:
detecting, in the beacon frame, an information element having a header the value of which is specific for all the information elements carrying vendor specific content,
and detecting in the detected information element, a predetermined organization identifier;
and extracting, from the recognized data, the information about storage capabilities, the processor is configured for extracting this information from sub-elements carried by the detected information element.
